(19) United States
(12) Patent Application Publication
(10) Pub. No.: US 2026/0047530 A1
(43) Pub. Date: Feb. 19, 2026

(54) CORN KERNEL CUTTING APPARATUS

(71) Applicant: Ronald John Calzone, Dixon, MO (US)

(72) Inventor: Ronald John Calzone, Dixon, MO (US)

(21) Appl. No.: 18/808,301

(22) Filed: Aug. 19, 2024

Related U.S. Application Data
(60) Provisional application No. 63/527,215, filed on Jul. 17, 2023.

(51) Int. Cl. A01F 11/06

(52) U.S. Cl. CPC A01F 11/06

(57) ABSTRACT

A self-aligning power-assisted corn kernel cutting apparatus is provided. The apparatus includes a cylindrical shell ported housing coupled to an actuation mechanism at a first end and an annular cutting mechanism at a second end. The actuation mechanism includes a power-assisted piston rod coupled to self-aligning plunger via a spring and an inner plunger disposed within the self-aligning plunger. In operation a user places an ear of corn within the ported housing wherein self-aligning plunger is force down upon the ear causing the ear to align properly. Power assistance is provided to the actuation mechanism which forces the ear over the annular cutting mechanism ejecting kernels through at least one port into an optional toroidal bowl. Once actuation mechanism bottoms out inner plunger forces the cob through an ejection tube.

### CROSS-REFERENCE TO RELATED APPLICATION

This application claims the benefit of priority of U.S. provisional application No. 63/527,215, filed Jul. 17, 2023, the contents of which are herein incorporated by reference.

### BACKGROUND OF THE INVENTION

The present invention relates to food processing apparatuses, and, more particularly, to a corn kernel cutting apparatus configured to automatically center an ear of corn, cut the kernels off the cob, and dispose of the cob.

Processing fresh corn, particularly cutting kernels from the ears, is time consuming, unsafe, and labor intensive for home gardeners and small producers who are unable to afford the elaborate machines used by high volume food production facilities.

Kernel cutting is currently usually reduced to cutting kernels off the ears of with a handheld straight knife or curved blade that, not only, exposes the user to dangerous sharp edges, but results in incomplete removal of the kernels or kernels that are damaged. The manual nature of this process is fatiguing and thereby often limits the volume of food that small commercial operators and home gardeners can produce.

There exist corn kernel cutting apparatuses such as U.S. Pat. No. 11,839,180 and the ShuckBuddy. However, the designs of the '180 patent and the Shuckbuddy are disadvantageous because they include no mechanism for self-centering an ear of corn or maintaining axial alignment of the moving parts, leading to uneven removal of kernels. Furthermore, the '180 patent includes an exposed cutting mechanism and the Shuckbuddy includes a fast-acting pneumatic plunger with no caging, both of which expose a user, who must hold an ear of corn in place, to potential injury due to unshielded components. Prior art can also be difficult to manufacture, since the components do not inherently align along the axis of operation. In addition to the above disadvantages, prior art apparatuses typically result in bulky products that are difficult to ship and store when not in use.

As can be seen, there is a need for an improved corn kernel cutting apparatus configured to self-align an ear of corn during the entire kernel cutting process and provide uniform cutting, which also includes caging to prevent injury to a user. Additionally, the present invention can be manufactured almost completely by mill-turn CNC equipment simplifying both assembly and use in the field.

### SUMMARY OF THE INVENTION

In one aspect of the present invention, a corn kernel cutting apparatus is provided with a body shaped as a cylindrical shell having a first annular base, a second annular base, a first plurality of ports, and a second plurality of ports. An actuation mechanism is coupled to the body proximate to the first annular base and is configured to provide power-assisted force to automatically press an ear of corn through the cutting process. The actuation mechanism can be compressibly coupled to an outer plunger, using a spring, having a conical shape and an inner bore. Additionally, an inner plunger can be coupled to the actuation mechanism and can be at least partially disposed within the spring and within the inner bore of the outer plunger. A receiver is coupled to the body proximate to the second annular base.

The receiver is shaped as a cylindrical shell having at least two annular bases with differing widths. A conically frustum shaped annular knife continuously formed to a cylindrical base is mounted to the receiver. The annular knife includes an inner bore of sufficient diameter for a cob of an ear of corn to pass through. A chute is coupled to the body proximate to the second annular base and can be shaped as a cylindrical shell and coupled to the body proximate to the second annular base. Optionally, a toroidal shaped bowl can be affixed to the body proximate to the second annular base and is configured to collect kernels cut from an ear of corn.

In another aspect, operation of the present invention is provided. The corn kernel cutting apparatus can be connected to a pneumatic source, such as an air compressor, and can include components for flow control and actuation. In operation, an ear of corn can be placed into the corn kernel cutting apparatus through one of the first plurality of ports. A user can actuate the apparatus through a button, switch, or other mechanism, which can cause outer plunger and inner plunger to come into contact with the ear of corn 10 through pneumatic force transmitted from the actuation mechanism. Upon initial contact, outer plunger can cause ear of corn to become, and remain, axially centered within the body. The pneumatic force of actuation mechanism causes ear of corn to pass through the annular knife, separating and ejecting kernels through the second plurality of ports and into an optional bowl, while the cob passes through the inner bore of annular knife.

Once outer plunger comes into contact with annular knife thereby ceasing advancement, the spring begins to compress thereby maintaining contact between the inner plunger and the cob of corn and forcing the cob through the cob chute. In embodiments, at maximum compression of spring, the inner plunger causes cob of corn to become completely ejected through cob chute. Once the cob is ejected, the actuation mechanism returns to its original position to accept subsequent ears of corn, thereby providing a repeated kernel cutting process.

These and other features, aspects and advantages of the present invention will become better understood with reference to the following drawings, description, and claims.

### BRIEF DESCRIPTION OF THE DRAWINGS

FIG. 1 is a perspective view of an embodiment of a corn kernel cutting apparatus, in accordance with aspects of the present invention;

FIG. 2 is a front elevation view of an embodiment of a corn kernel cutting apparatus, in accordance with aspects of the present invention;

FIG. 3 is an exploded view of an embodiment of a corn kernel cutting apparatus, in accordance with aspects of the present invention;

FIG. 4 is a cross-sectional view of an embodiment of a corn kernel cutting apparatus taken along line 4-4 of FIG. 1, in accordance with aspects of the present invention;

FIG. 5 is a cross-sectional view of an embodiment of a corn kernel cutting apparatus taken along line 4-4 of FIG. 1 showing operation of a conical plunger, in accordance with aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is an improved corn kernel cutting apparatus. The improved corn kernel cutting apparatus includes a cylindrical cutting chamber where a hand-fed ear of corn can be automatically oriented and centrally aligned. A pneumatically driven conical plunger can assist in centering the ear of corn and can drive the ear of corn through an annular knife configured to remove kernels. The annular knife is disposed within the cylindrical cutting chamber and has an inner diameter slightly larger than a corn cob to provide uniform cutting of kernels allowing the cob to pass through during the cutting process. The components of the present invention are designed to be inherently suitable for production by mill-turn CNC equipment, and naturally align, thereby simplifying manufacturing, assembly and use in the field.

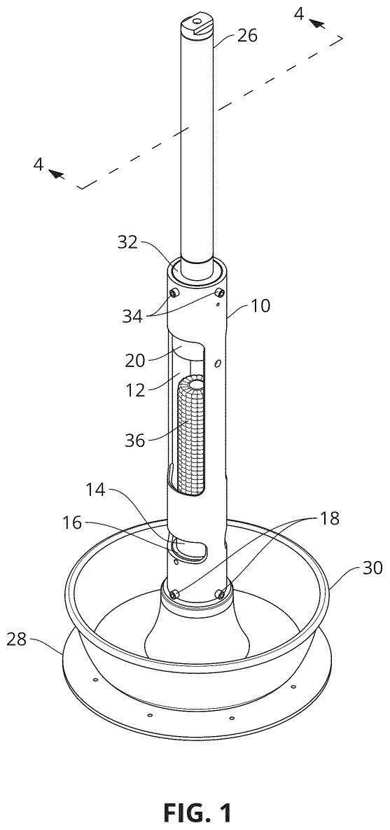

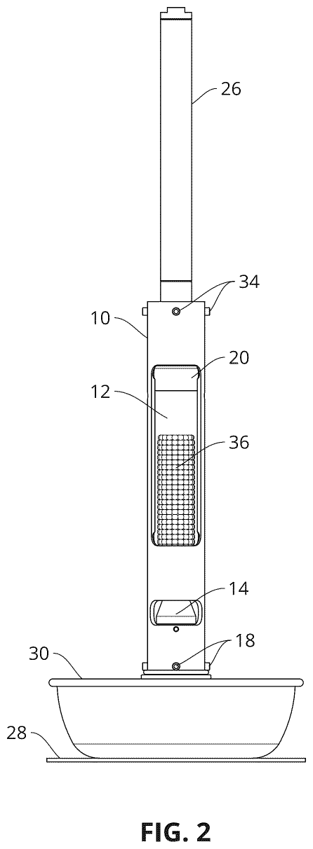

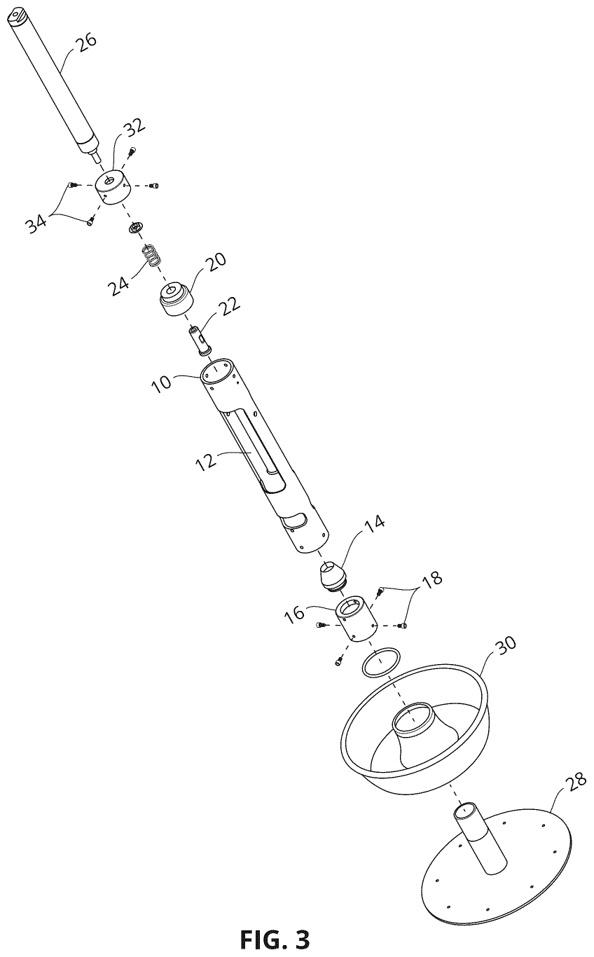

Referring to FIGS. 1-5, aspects of an improved corn kernel cutting apparatus are illustrated. The improved corn kernel cutting apparatus can include a body 10 configured to vertically orient ear of corn 36, or maize. In embodiments, body 10 can be a vertically oriented ported cylinder, or cylindrical shell, with sufficient inner diameter to accommodate ear of corn 36, or maize. Ported cylinder of body 10 can include a first annular base, a second annular base, a first plurality of ports 12 disposed opposite each other on body 10 and configured to receive ear of corn 36. Ported cylinder of body 10 can include a second plurality of ports 17 disposed opposite each other on body 10, and proximate to a bottom of body 10, as illustrated in FIG. 3, and configured to discharge kernels removed from ear of corn 36. Body 10 can serve as a housing for all internal components of the improved corn kernel cutting apparatus, thereby providing protection to a user. Additionally, body 10 can provide support for ear of corn 36 when introduced, thus negating any further user intervention in the kernel cutting process.

An actuation mechanism 26 can be coupled to body 10 proximate to the first annular base and can be configured to advance ear of corn 36 through the cutting process. In embodiments, actuation mechanism 26 can include a cylindrical housing with a piston coupled to a first end of a piston rod housed therein. In embodiments, actuation mechanism 26 can be pneumatically powered through a pressurized air tube connected to a top portion of actuation mechanism 26. In an alternative embodiment, actuation mechanism 26 can be a suitable linear actuator, such as hydraulic, electromechanical, or piezoelectric. In embodiments, actuation mechanism 26 can include a controller, such as a flow control valve, configured to control flow rate. Advantageously, actuation mechanism 26 can provide the necessary force to drive corn 36 through the kernel cutting process without the need for user intervention.

Piston rod of actuation mechanism 26 can be operatively coupled, at a second end, to a stopper 32, via a plurality of fasteners 34. In embodiments, the plurality of fasteners 34 can be screws, nuts and bolts, and/or any other known fastening mechanism. In embodiments, stopper 32 can be a cylinder, or cylindrical shell, with an inner bore of sufficient diameter to accept a tip of the second end of the piston rod and is additionally configured to house a spring backing (unlabeled) in a portion of the inner bore. Spring backing (unlabeled) can be in contact with a first end of spring 24 and is configured to transmit force applied to stopper 32, by actuation mechanism 26, to spring 24.

A second end of spring 24 can be in contact with a conical plunger 20 and is configured to transmit force from actuation mechanism 26 to conical plunger 20. In embodiments, conical plunger 20 is monolithically formed as a plurality of stacked cylinders, having a common axis, each cylinder having a differing outer diameter and a common inner bore. In embodiments, conical plunger 20 can have an inner recessed portion within a first of the plurality of stacked cylinders, substantially conical in shape, or shaped substantially as a conical frustum, configured to provide axial alignment and centering of corn 36 during operation. Furthermore, the common inner bore of conical plunger 20 can be of sufficient diameter to house an inner plunger 22 and allow movement of inner plunger 22. Advantageously, conical plunger 20, through the inner recessed portion, can provide automatic axial centering of corn 36 throughout the kernel cutting process without the need for user intervention beyond insertion of corn 36.

Inner plunger 22 can be monolithically formed of a plurality of stacked cylinders having differing outer diameters and is configured to transmit force from actuation mechanism 26 to corn 36 during a last part of the kernel cutting process. Inner plunger 22 can have portions thereof movably housed within both the inner bore of conical plunger 20 and spring 24 and can have a first end in contact with spring backing (unlabeled). Advantageously, inner plunger 22 can provide for advancement and disposal of the cob of corn 36 when conical plunger 20 bottoms out.

Referring now to a cutting mechanism of the apparatus, the cutting mechanism can consist of an annular knife 14, a receiver 16, and a base 28. Annular knife 14 can be shaped substantially as a conical frustum, monolithically formed to a cylindrical base, having an inner bore of sufficient diameter to pass an ear of corn 36 or maize. The base of annular knife 14 can be mounted to the interior of body 10 by receiver 16, which can include an inner bore of sufficient diameter to allow a corn cob stripped of kernels to pass through. In embodiments, receiver 16 can be mounted proximate to the second annular base of an interior of body 10 by one or more fasteners 18. In embodiments, receiver 16 can include a shoulder portion having a first inner diameter configured to mate with base of annular knife 14. Additionally, receiver 14 can have a second inner diameter extending from shoulder portion to a second end, larger than the first inner diameter, configured to house at least a portion of base 28. Base 28 can include a substantially tubular in shape having a first annular base, a second annular base, and an inner bore of sufficient diameter to allow a cob of corn 36 stripped of kernels to pass through, and can include a cylindrical base attached at a second base of the tubular shape configured to support the corn kernel cutting apparatus. Advantageously, the cutting mechanism allows for complete, uniform, and efficient removal of corn kernels, while providing quick disposal of the stripped cob.

Referring now to additional aspects of the corn kernel cutting apparatus, an optional bowl 30 can be provided to collect kernels from corn 36. In embodiments, bowl 30 can be torus-shaped, or toroidal, and can be affixed proximate to the second plurality ports and/or proximate to the second annular base. Advantageously, bowl 30 provides for collection of kernels of corn 36 during the kernel cutting process.

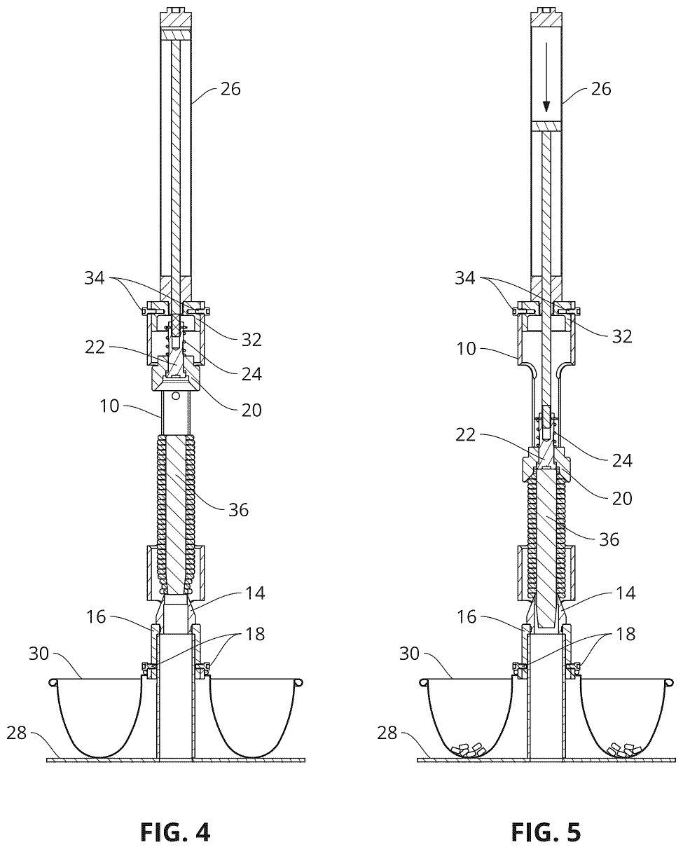

Referring now to operation of the corn kernel cutting apparatus, as illustrated in FIG. 4-5, the apparatus can be connected to a pneumatic source, such as an air compressor, and can include components for flow control and actuation. In operation an ear of corn 36 can be placed into body 10 of corn kernel cutting apparatus through one of the first plurality of ports 12. A user can actuate the apparatus through a button, switch, or other mechanism, which can cause conical plunger 20 and inner plunger 22 to come into contact with the ear of corn 36 through pneumatic force transmitted from actuation mechanism 26. Upon initial contact, conical plunger 20 can cause ear of corn to become, and remain, axially centered within body 10. The pneumatic force of actuation mechanism 26 causes ear of corn 36 to pass through annular knife 14, separating and ejecting kernels through the second plurality of ports and into optional bowl 30, while the cob passes through the inner bore of annular knife 14. In embodiments, the pneumatic force provided causes minimal compression of spring 24 during advancement of conical plunger 20.

Once conical plunger 20 comes into contact with annular knife thereby ceasing advancement, spring 24 begins to compress thereby maintaining contact between inner plunger 20 and the cob of corn 36 and forcing the cob through base 28. In embodiments, at maximum compression of spring 24, inner plunger 22 can cause cob of corn 36 to become completely ejected through base 28. Once the cob is ejected, actuation mechanism 26 returns to its original position to accept subsequent ears of corn, thereby providing a repeated kernel cutting process.

It should be understood, of course, that the foregoing relates to exemplary embodiments of the invention and that modifications may be made without departing from the spirit and scope of the invention as set forth in the following claims.

What is claimed is:

1. A corn kernel cutting apparatus, comprising:
a body shaped as a cylindrical shell with a first annular base, a second annular base, a first plurality of ports, and a second plurality of ports;
an actuation mechanism coupled to the body proximate to the first annular base;
a receiver coupled to the body proximate to the second annular base, wherein the receiver is shaped as a cylindrical shell having a third annular base with a first width and a fourth annular base with a second width; and
an annular knife mounted to the third annular base of the receiver.

2. The corn kernel cutting apparatus of claim 1, further comprising:
an outer plunger having a conical shape and an inner bore, the outer plunger compressibly coupled to the actuation mechanism by a spring;
an inner plunger coupled to the actuation mechanism and at least partially disposed within the inner bore of the outer plunger and within the spring.

3. The corn kernel cutting apparatus of claim 1, further comprising:
a toroidal shaped bowl affixed to the body proximate to the second annular base.

4. The corn kernel cutting apparatus of claim 1, wherein the annular knife is shaped as a conical frustum with a cylindrical base.

5. The corn kernel cutting apparatus of claim 1, wherein the actuation mechanism is pneumatically driven.

6. The corn kernel cutting apparatus of claim 2, the actuation mechanism further comprising:
a stopper coupled to the actuation mechanism and configured transfer force from the actuation mechanism to the outer plunger and the inner plunger.
